(19) United States
(12) Patent Application Publication
(10) Pub. No.: US 2018/0149350 A1
(43) Pub. Date: May 31, 2018

(54) Conductor Concealment System

(71) Applicant: Tonnie Johnson-Gray, New Albany, MS (US)

(72) Inventor: Tonnie Johnson-Gray, New Albany, MS (US)

(21) Appl. No.: 15/364,732

(22) Filed: Nov. 30, 2016

(51) Int. Cl. F21V 33/00; H01R 13/05; H01R 13/11; H01R 24/30; H01R 24/78; H02J 7/35; F21S 9/03

(52) U.S. Cl. CPC F21V 33/0004; H01R 13/055; H01R 13/113; H01R 2103/00; H01R 24/78; H02J 7/355; F21S 9/035; H01R 24/30

(57) ABSTRACT

A conductor concealment system includes a plurality of electrical cords and each of the electrical cords includes a male plug. An outlet unit is provided and the outlet unit is positioned outdoors. The male plug corresponding to each of the electrical cords is selectively electrically coupled to the outlet unit. The outlet unit is electrically coupled to a power source such that each of the electrical cords is in electrical communication with the power source. A lighting unit is removably coupled to the outlet unit to inhibit the male plug corresponding to each of the electrical cords from being exposed to weather. The lighting unit emits light to illuminate an area proximate the lighting unit.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM.

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

### (2) Description of Related Art including information disclosed under 37 CFR 1.97 and 1.98

The disclosure and prior art relates to concealment devices and more particularly pertains to a new concealment device for inhibiting electrical outlets from being exposed to weather.

### BRIEF SUMMARY OF THE INVENTION

An embodiment of the disclosure meets the needs presented above by generally comprising a plurality of electrical cords and each of the electrical cords includes a male plug. An outlet unit is provided and the outlet unit is positioned outdoors. The male plug corresponding to each of the electrical cords is selectively electrically coupled to the outlet unit. The outlet unit is electrically coupled to a power source such that each of the electrical cords is in electrical communication with the power source. A lighting unit is removably coupled to the outlet unit to inhibit the male plug corresponding to each of the electrical cords from being exposed to weather. The lighting unit emits light to illuminate an area proximate the lighting unit.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a top perspective view of a conductor concealment system according to an embodiment of the disclosure.

FIG. 2 is a back view of an embodiment of the disclosure.

FIG. 3 is a right side phantom view of an embodiment of the disclosure.

FIG. 4 is a top view of an embodiment of the disclosure.

FIG. 5 is an exploded perspective view of an embodiment of the disclosure.

### DETAILED DESCRIPTION OF THE INVENTION

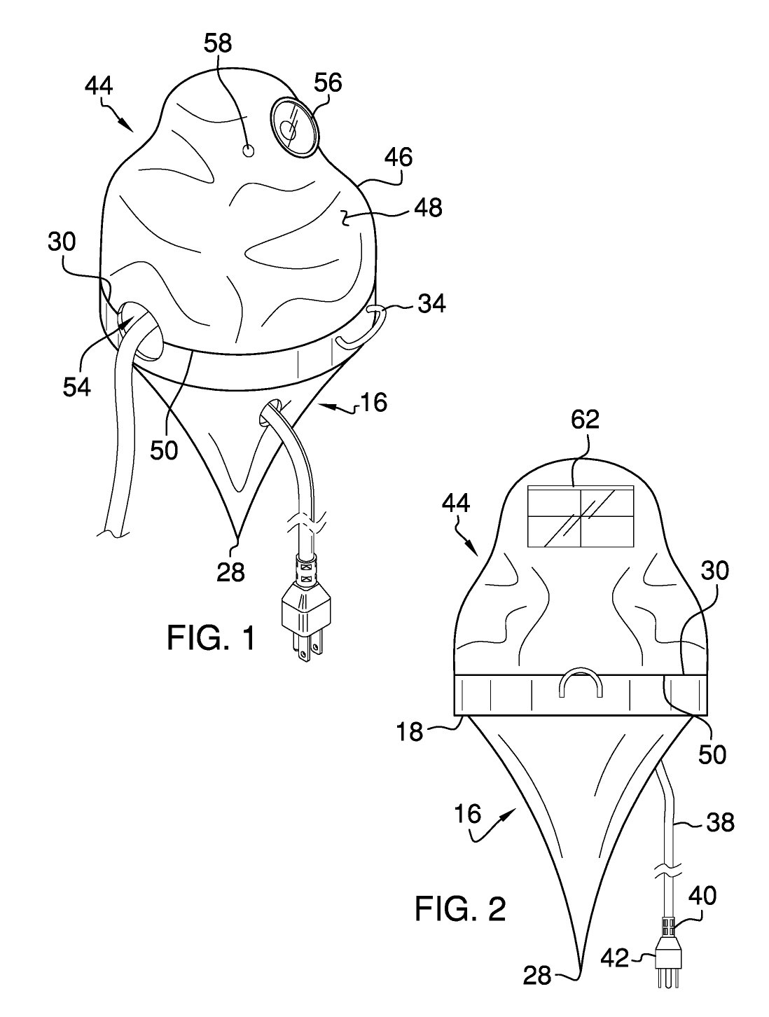

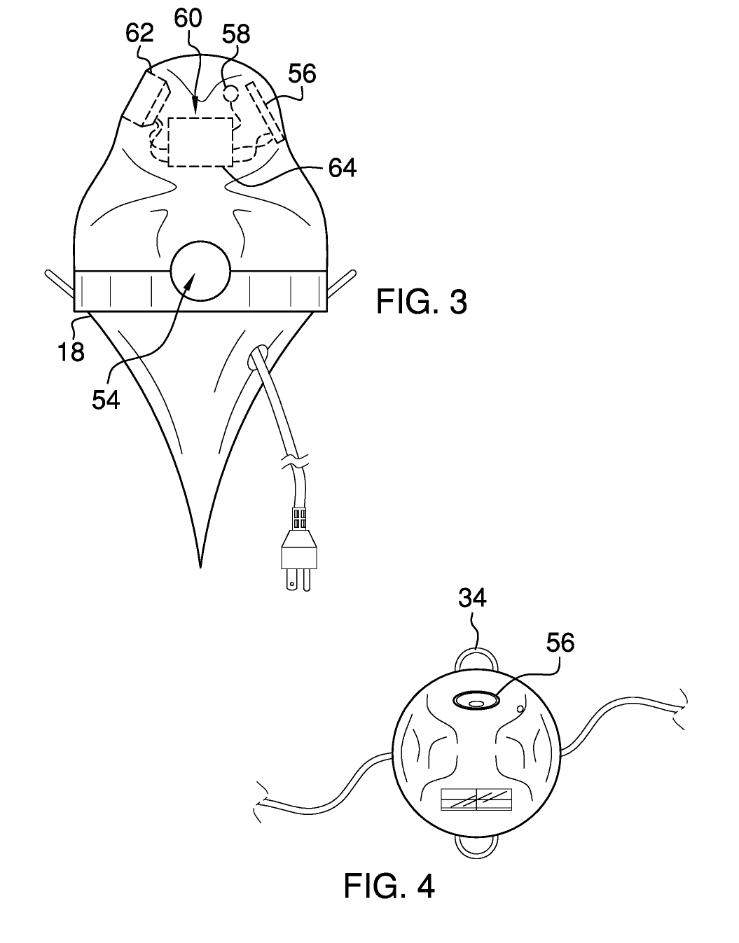

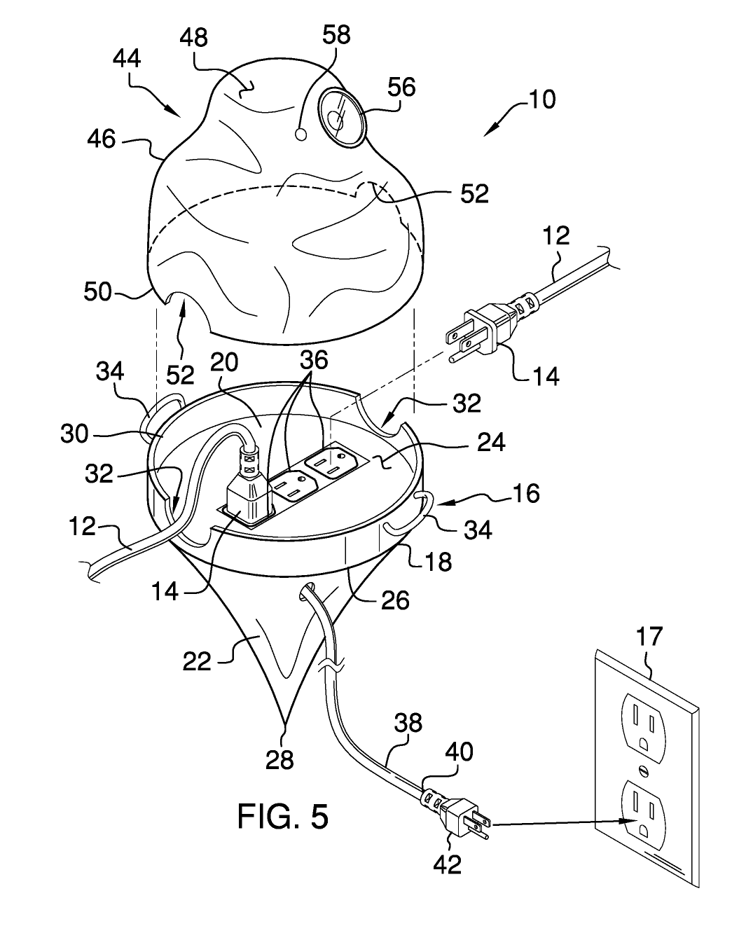

With reference now to the drawings, and in particular to FIGS. 1 through 5 thereof, a new concealment device embodying the principles and concepts of an embodiment of the disclosure and generally designated by the reference numeral 10 will be described.

As best illustrated in FIGS. 1 through 5, the conductor concealment system 10 generally comprises a plurality of electrical cords 12 and each of the electrical cords 12 includes a male plug 14. Each of the electrical cords 12 may be extension cords, power cords for electrical appliances or any other electrical cord that can be plugged into a female electrical outlet. An outlet unit 16 is provided and the outlet unit 16 is positioned outdoors in a garden or the like. The male plug 14 corresponding to each of the electrical cords 12 is selectively electrically coupled to the outlet unit 16. The outlet unit 16 is electrically coupled to a power source 17 such that each of the electrical cords 12 is in electrical communication with the power source 17.

The outlet unit 16 comprises a housing 18 that includes a disk 20 and a bottom wall 22. The disk 20 has a top surface 24 and a bottom surface 26. The bottom wall 22 extends away from the bottom surface 26 and the bottom wall 22 is coextensive with a perimeter of the disk 20. The bottom wall 22 tapers to a distal point 28 with respect to the disk 20. The distal point 28 may penetrate ground such that the housing 18 is retained at a selected position outdoors. The bottom wall 22 extends upwardly beyond the disk 20 to define a distal edge 30 with respect to the disk 20. The distal edge 30 has a pair of first slots 32 extending toward the disk 20 and the first slots 32 are spaced apart from each other.

A pair of loops 34 is provided and each of the loops 34 is coupled to the bottom wall 22. The loops 34 are spaced apart from each other and are distributed around the disk 20. Each of the loops 34 is selectively coupled to a support thereby facilitating the housing 18 to be suspended from the support.

A plurality of electrical outlets 36 is provided and each of the electrical outlets 36 extends through the top surface 24 of the disk 20. The male plug 14 corresponding to each of the electrical cords 12 is selectively plugged into and is electrically coupled to an associated one of the electrical outlets 36. Each of the electrical outlets 36 may be female electrical outlets 36 of any conventional design.

A power cord 38 is coupled to and extends outwardly from the housing 18. The power cord 38 is electrically coupled to each of the electrical outlets 36 and the power cord 38 has a distal end 40 with respect to the housing 18. A plug 42 is electrically coupled to the distal end 40 and the plug 42 is selectively electrically coupled to the power source 17. The power source 17 may be an electrical outlet or the like.

A lighting unit 44 is provided and the lighting unit 44 is removably coupled to the outlet unit 16. The lighting unit 44 inhibits the male plug 14 corresponding to each of the electrical cords 12 from being exposed to weather. Additionally, the lighting unit 44 emits light to illuminate an area proximate the lighting unit 44.

The lighting unit 44 comprises a dome 46 that has an outer surface 48 and a peripheral edge 50. The dome 46 is removably positioned on the housing 18 having the peripheral edge 50 abutting the distal edge 30 of the housing 18. The dome 46 is structured to have the ornamental appearance of a rock or the like. Moreover, the dome 46 is comprised of a fluid impermeable material such as plastic or the like.

The peripheral edge 50 has a pair of second slots 52 extending upwardly thereon. Each of the second slots 52 is aligned with an associated one of the first slots 32 to form a plurality of holes 54 when the dome 46 is positioned on the housing 18. Moreover, each of the electrical cords 12 extends through an associated one of the holes 54. In this way the dome 46 covers each of the electrical outlets 36 and the corresponding male plugs 14 thereby inhibiting the electrical outlets 36 and the corresponding male plugs 14 from being exposed to weather.

A light emitter 56 is coupled to the outer surface 48 of the dome 46 to emit light outwardly from the dome 46. Thus, the light emitter 56 illuminates the area near the dome 46 thereby facilitating an individual to walk in the area at night. The light emitter 56 may be an LED or the like.

A light sensor 58 is provided and the light sensor 58 is coupled to the outer surface 48 of the dome 46 to detect sunlight. The light sensor 58 is electrically coupled to the light emitter 56. The light sensor 58 turns the light emitter 56 on when the light sensor 58 does not detect sunlight and the light sensor 58 turns the light emitter 56 off when the light sensor 58 detects sunlight. The light sensor 58 may be an electronic light sensor 58 or the like.

A power supply 60 is provided and the power supply 60 is coupled to the dome 46. The power supply 60 is electrically coupled to the light emitter 56. The power supply 60 comprises a solar cell 62 that is coupled to the outer surface 48 of the dome 46 to convert sunlight into electrical energy. The solar cell 62 may be a solar cell 62 of any conventional design.

A battery 64 is provided and the battery 64 is coupled to the dome 46. The battery 64 is electrically coupled to the light emitter 56. Additionally, the battery 64 is electrically coupled to the solar cell 62 such that the solar cell 62 charges the battery 64. The battery 64 may be a rechargeable battery or the like.

In use, the distal point 28 of the housing 18 is urged to penetrate the ground. Each of the male plugs 14 is plugged into an associated one of the electrical outlets 36. The dome 46 is positioned on the housing 18 and each of the electrical cords 12 is positioned in an associated one of the holes 54. The light sensor 58 turns the light emitter 56 on when the sun is not shining. Thus, the light emitter 56 illuminates the area adjacent to the housing 18 at night. The solar cell 62 charges the battery 64 during daylight hours.

With respect to the above description then, it is to be realized that the optimum dimensional relationships for the parts of an embodiment enabled by the disclosure, to include variations in size, materials, shape, form, function and manner of operation, system and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A conductor concealment system comprising:
a plurality of electrical cords, each of said electrical cords having a male plug being electrically coupled thereto;
an outlet unit being configured to be positioned outdoors, said male plug corresponding to each of said electrical cords being selectively electrically coupled to said outlet unit, said outlet unit being configured to be electrically coupled to a power source such that each of said electrical cords is in electrical communication with the power source; and
a lighting unit being removably coupled to said outlet unit wherein said lighting unit is configured to inhibit said male plug corresponding to each of said electrical cords from being exposed to weather, said lighting unit emitting light wherein said lighting unit is configured to illuminate an area proximate said lighting unit.

2. The system according to claim 1, wherein said outlet unit comprises a housing having a disk and a bottom wall, said disk having a top surface and a bottom surface, said bottom wall extending away from said bottom surface and being coextensive with a perimeter of said disk, said bottom wall tapering to a distal point with respect to said disk wherein said distal point is configured to penetrate ground such that said housing is retained at a selected position outdoors.

3. The system according to claim 2, wherein said bottom wall extends upwardly beyond said disk to define a distal edge with respect to said disk, said distal edge having a pair of first slots extending toward said disk, said first slots being spaced apart from each other.

4. The system according to claim 2, further comprising a plurality of electrical outlets, each of said electrical outlets extending through said top surface of said disk, said male plug corresponding to each of said electrical cords being selectively plugged into and being electrically coupled to an associated one of said electrical outlets

5. The system according to claim 4, further comprising a power cord extending outwardly from said housing, said power cord being electrically coupled to each of said electrical outlets, said power cord having a distal end with respect to said housing, said distal end having a plug being electrically coupled thereto, said plug being configured to be electrically coupled to the power source.

6. The system according to claim 1, wherein:
said outlet unit includes a housing having a distal edge; and
said lighting unit comprises a dome having an outer surface and a peripheral edge, said dome being removably positioned on said housing having said peripheral edge abutting said distal edge of said housing.

7. The system according to claim 6, wherein:
said distal edge has a plurality of first slots; and
said peripheral edge has a pair of second slots extending upwardly thereon, each of said second slots being aligned with an associated one of said first slots to form a plurality of holes when said dome is positioned on said housing, each of said electrical cords extending through an associated one of said holes.

8. The system according to claim 6, further comprising a light emitter being coupled to said outer surface of said dome wherein said light emitter is configured to emit light outwardly from said dome.

9. The system according to claim 8, further comprising a light sensor being coupled to said outer surface of said dome wherein said light sensor is configured to detect sunlight, said light sensor being electrically coupled to said light emitter, said light sensor turning said light emitter on when said light sensor does not detect sunlight.

10. The system according to claim 8, further comprising a power supply being coupled to said dome, said power supply being electrically coupled to said light emitter.

11. The system according to claim 10, wherein said power supply comprises:
a solar cell being coupled to said outer surface of said dome wherein said solar cell is configured to convert sunlight into electrical energy; and
a battery being coupled to said dome, said battery being electrically coupled to said light emitter, said battery being electrically coupled to said solar cell such that said solar cell charges said battery.

12. A conductor concealment system comprising:
a plurality of electrical cords, each of said electrical cords having a male plug being electrically coupled thereto;
an outlet unit being configured to be positioned outdoors, said male plug corresponding to each of said electrical cords being selectively electrically coupled to said outlet unit, said outlet unit being configured to be electrically coupled to a power source such that each of said electrical cords is in electrical communication with the power source, said outlet unit comprising:
a housing having a disk and a bottom wall, said disk having a top surface and a bottom surface, said bottom wall extending away from said bottom surface and being coextensive with a perimeter of said disk, said bottom wall tapering to a distal point with respect to said disk wherein said distal point is configured to penetrate ground such that said housing is retained at a selected position outdoors, said bottom wall extending upwardly beyond said disk to define a distal edge with respect to said disk, said distal edge having a pair of first slots extending toward said disk, said first slots being spaced apart from each other,
a plurality of electrical outlets, each of said electrical outlets extending through said top surface of said disk, said male plug corresponding to each of said electrical cords being selectively plugged into and being electrically coupled to an associated one of said electrical outlets, and
a power cord extending outwardly from said housing, said power cord being electrically coupled to each of said electrical outlets, said power cord having a distal end with respect to said housing, said distal end having a plug being electrically coupled thereto, said plug being configured to be electrically coupled to the power source; and
a lighting unit being removably coupled to said outlet unit wherein said lighting unit is configured to inhibit said male plug corresponding to each of said electrical cords from being exposed to weather, said lighting unit emitting light wherein said lighting unit is configured to illuminate an area proximate said lighting unit, said lighting unit comprising:
a dome having an outer surface and a peripheral edge, said dome being removably positioned on said housing having said peripheral edge abutting said distal edge of said housing, said peripheral edge having a pair of second slots extending upwardly thereon, each of said second slots being aligned with an associated one of said first slots to form a plurality of holes when said dome is positioned on said housing, each of said electrical cords extending through an associated one of said holes,
a light emitter being coupled to said outer surface of said dome wherein said light emitter is configured to emit light outwardly from said dome,
a light sensor being coupled to said outer surface of said dome wherein said light sensor is configured to detect sunlight, said light sensor being electrically coupled to said light emitter, said light sensor turning said light emitter on when said light sensor does not detect sunlight, and
a power supply being coupled to said dome, said power supply being electrically coupled to said light emitter, said power supply comprising:
a solar cell being coupled to said outer surface of said dome wherein said solar cell is configured to convert sunlight into electrical energy, and
a battery being coupled to said dome, said battery being electrically coupled to said light emitter, said battery being electrically coupled to said solar cell such that said solar cell charges said battery.
